(19) United States
(12) Patent Application Publication
(10) Pub. No.: US 2003/0067984 A1
(43) Pub. Date: Apr. 10, 2003

(54) Apparatus and method of coding/decoding moving picture and storage medium for storing coded moving picture data

(75) Inventor: Kenji Sugiyama, Yokosuka-shi (JP)

Correspondence Address: JACOBSON HOLMAN PLLC, 400 SEVENTH STREET N.W., SUITE 600, WASHINGTON, DC, 20004, US

(73) Assignee: Victor Company of Japan, Ltd.

(21) Appl. No.: 10/291,421

(22) Filed: Nov. 12, 2002

Related U.S. Application Data
(62) Division of application No. 09/200,707, filed on Nov. 27, 1998.

(30) Foreign Application Priority Data
Nov. 28, 1997 (JP) 344322/1997

(51) Int. Cl. H04N 7/12

(52) U.S. Cl. 375/240.13

(57) ABSTRACT

An input moving picture signal is selectively coded by intra-picture coding or inter-picture coding in unit of frame or field to output a main bit stream. Specific frames or fields carried by the input moving picture signal are coded by intra-picture coding to output a subsidiary bit stream. The specific frames or fields are also coded by the inter-picture coding. The main and subsidiary bit streams are multiplexed so that the subsidiary bit streams are periodically inserted in the main bit stream in the vicinity of a predetermined number of the frames or fields coded by the inter-picture coding, thus generating an output bit stream. In decoding, a coding-type of the bit stream is detected and a coding-type signal is generated. The main and the subsidiary bit streams are selectively output in response to the coding-type signal in such a way that both the main and the subsidiary bit streams are output when no continuous decoding is being performed, while the main bit stream only is output when continuous decoding is being performed. The output bit stream is decoded to reproduce pictures carried by the input bit stream.

### BACKGROUND OF THE INVENTION

The present invention relates to highly efficient coding to convert picture information into digital signals with a small amount of codes for effectively transferring, storing and displaying the picture information. Furthermore, this invention relates to highly efficient coding for moving pictures with inter-picture predictive coding applicable to channel switching, random access, etc.

Highly efficient coding for moving pictures with inter-picture predictive coding provides a very small amount of coded data. On the other hand, the inter-picture predictive coding requires independent (intra-picture coded) frames (or fields) which are coded independently to be applicable to channel switching among TV channels, for example, or random access to storage media, etc. Because the inter-picture predictive coding requires already decoded independent frames (fields) for decoding other frames (fields). Each independent frame (or field) generally contains codes the amount of which is three to ten times an inter-picture predictive-coded frame (field). The more the independent frames (fields), the lower the coding efficiency. The inter-picture predictive coding usually requires one independent frame (field) for every 15th-frame that corresponds to 0. 5 seconds.

Intraframe (field) coding only for low frequency components yields not so large amount of codes compared to interframe (field) predictive coding. Coding efficiency is thus not so low even many independent frames (fields) of low frequency components are provided. This is disclosed in Japanese unexamined patent publication No. 1993 (5)-122686. Since independent frames (fields) are reproduced as pictures of low frequency components, channel switching or random access initially reproduces pictures of low resolution and then pictures of high resolution that are gradually close to original pictures.

However, coding described above has drawbacks. Conventional moving picture coding yields a large amount of codes for each independent frame (field), thus having difficulty providing many independent frames (fields) with high coding efficiency. This is therefore not applicable to channel switching, random access, high-speed picture search, etc.

Furthermore, the coding disclosed in Japanese unexamined patent publication No. 1993 (5)-122686 requires filters for removing low frequency components for decoding. Code errors if occurred will continue until a next independent frame (filed) is produced.

### SUMMARY OF THE INVENTION

A purpose of the present invention is to provide an apparatus and a method of efficiently coding a moving picture signal that output a bit stream which is applicable to quick channel switching, random access, etc., high-speed search and also code error correction.

Another purpose of the present invention is to provide an apparatus and a method of efficiently decoding such bit stream

A further purpose of the present invention is to provide a storage medium for storing such bit stream.

The present invention provides an apparatus for efficiently coding a moving picture signal. The coding apparatus includes a main coding processor and a subsidiary coding processor. The main coding processor selectively encodes an input moving picture signal by intra-picture coding or inter-picture coding in unit of frame or field to output a main bit stream. The subsidiary coding processor encodes specific frames or fields carried by the input moving picture signal by intra-picture coding to output a subsidiary bit stream, the specific frames or fields being also coded by the inter-picture coding by the main coding processor. The coding apparatus further includes a multiplexer that multiplexes the main and subsidiary bit streams so that the subsidiary bit streams are periodically inserted in the main bit stream in the vicinity of a predetermined number of the frames or fields coded by the inter-picture coding, thus generating an output bit stream.

The present invention further provides an apparatus for efficiently decoding a moving picture signal. The decoding apparatus includes a detector that detects a coding-type of an input bit stream formed by multiplexing a main bit stream of frames or fields and subsidiary bit streams, the subsidiary bit streams being periodically inserted in the main bit stream in the vicinity of a predetermined number of the frames or fields, the main bit stream having been coded at quantization steps finer than other quantization steps at which the subsidiary bit streams having been coded, and a coding-type information indicating whether the main bit stream is or the subsidiary bit streams are input, the detector detecting the coding-type information and generating a coding-type signal. The decoding apparatus also includes a controller that selectively outputs the main and the subsidiary bit streams in response to at least the coding-type signal in such away that the controller outputs both the main and the subsidiary bit streams when no continuous decoding is being performed, while the controller outputs only the main bit stream when continuous decoding is being performed. The decoding apparatus further includes a decoder that decodes the output bit stream to reproduce pictures carried by the input bit stream.

Furthermore, the present invention provides an apparatus for efficiently decoding a moving picture signal. The decoding apparatus includes a first detector to detect a coding-type of an input bit stream formed by multiplexing a main bit stream of frames or fields and subsidiary bit streams, the subsidiary bit streams being periodically inserted in the main bit stream in the vicinity of a predetermined number of the frames or fields, the main bit stream having being coded at quantization steps finer than other quantization steps at which the subsidiary bit streams having been coded, and a coding-type information indicating whether the main bit stream is or the subsidiary bit streams are input, the detector detecting the coding-type information and generating a coding-type signal. The decoding apparatus also includes a second detector to detect an error of the input bit stream and generating an error indicating signal that indicates at which of the frames or fields the error occurs. The decoding apparatus further includes a controller, in response to the coding-type and error indicating signals, to replace the main bit stream of a frame or field with a subsidiary bit stream inserted in the vicinity thereof at which the error occurs with the subsidiary bit stream. The decoding apparatus still further includes a decoder to decode an output bit stream of the controller by intra-picture decoding or inter-picture predictive decoding to reproduce pictures carried by the input bit stream.

Furthermore, the present invention provides a method of efficiently coding a moving picture signal. An input moving picture signal is selectively coded by intra-picture coding or inter-picture coding in unit of frame or field to output a main bit stream. Specific frames or fields carried by the input moving picture signal are coded by intra-picture coding to output a subsidiary bit stream, the specific frames or fields being also coded by the inter-picture coding by the main coding processor. The main and subsidiary bit streams are multiplexed so that the subsidiary bit streams are periodically inserted in the main bit stream in the vicinity of a predetermined number of the frames or fields coded by the inter-picture coding, thus generating an output bit stream.

Furthermore, the present invention provides a method of efficiently decoding a moving picture signal. A coding-type of an input bit stream is detected, the input bit stream being formed by multiplexing a main bit stream of frames or fields and subsidiary bit streams, the subsidiary bit streams being periodically inserted in the main bit stream in the vicinity of a predetermined number of the frames or fields, the main bit stream having been coded at quantization steps finer than other quantization steps at which the subsidiary bit streams having been coded, and a coding-type information indicating whether the main bit stream is or the subsidiary bit streams are input, the detector detecting the coding-type information and generating a coding-type signal. The main and the subsidiary bit streams are selectively output in response to at least the coding-type signal in such a way that the controller outputs both the main and the subsidiary bit streams when no continuous decoding is being performed, while the controller outputs only the main bit stream when continuous decoding is being performed. The output bit stream is decoded to reproduce pictures carried by the input bit stream.

Furthermore, the present invention provides a method of efficiently decoding a moving picture signal. A coding-type of an input bit stream is detected, the input bit stream being formed by multiplexing a main bit stream of frames or fields and subsidiary bit streams, the subsidiary bit streams being periodically inserted in the main bit stream in the vicinity of a predetermined number of the frames or fields, the main bit stream having been coded at quantization steps finer than other quantization steps at which the subsidiary bit streams having been coded, and a coding-type information indicating whether the main bit stream is or the subsidiary bit streams are input, the coding-type information being detected, and generating a coding-type signal. An error of the input bit stream is detected to generate an error indicating signal that indicates at which of the frames or fields the error occurs. The main bit stream of a frame or field with a subsidiary bit stream inserted in the vicinity thereof at which the error occurs is replaced with the subsidiary bit stream in response to the coding-type and error indicating signals. The bit stream for which the main bit stream is replaced with the subsidiary bit stream is decoded by intra-picture decoding or inter-picture predictive decoding to reproduce pictures carried by the input bit stream.

The present invention further provides a storage medium including an area for storing moving picture data. The area includes main bit stream regions and subsidiary bit stream regions. Stored on the main bit stream regions are main bit streams formed by intra-picture coding and inter-picture predictive coding which are switched per frame or field of moving pictures. Stored on the subsidiary bit stream regions are subsidiary bit streams formed by intra-picture coding specific frames or fields among frames or fields that are also coded by the inter-picture predictive coding, the main and subsidiary bit streams being multiplexed so that the subsidiary bit streams being inserted in the vicinity of the main bit streams for specific frames or fields.

The term “picture” in this specification means “frame” or “field”.

The coding apparatus and method according the present invention generate the output bit stream that includes the main bit stream generated by the intra-picture coding and inter-picture coding and also the subsidiary bit streams generated by the intra-picture coding. Therefore, decrease in code amount of the main bit stream generated by the intra-picture coding does not affect the applicability of the output bit stream to decoding, such as, channel switching, random access, etc., because of the subsidiary bit streams. Furthermore, such decrease also decreases the total amount of the output bit stream, thus the present invention improving coding efficiency.

In decoding, the subsidiary bit streams generated by the intra-picture coding as well as the main bit stream generated by the intra-picture coding are decoded. In other words, the present invention provides many accessible frames or fields for channel switching, random access, high-speed search, etc. This invention thus achieves quick reproduction in channel switching and random access, and smooth searched pictures in high-speed search.

### BRIEF DESCRIPTION OF DRAWINGS

FIG. 1 is a block diagram of a preferred embodiment of the moving picture coding apparatus according to the present invention;

FIGS. 2A and 2B illustrate quantization steps for the quantizers shown in FIG. 1 for the main and subsidiary code processing, respectively;

FIG. 3 illustrates bit streams and timing for conventional coding and decoding;

FIG. 4 illustrates bit streams and timing for coding and decoding according to the present invention;

FIGS. 5A and 5B illustrate output code amounts for conventional coding and for coding according to the present invention, respectively;

FIG. 6 is a block diagram of the first preferred embodiment of the moving picture decoding apparatus according to the present invention; and

FIG. 7 is a block diagram of the second preferred embodiment of the moving picture decoding apparatus according to the present invention.

### DETAILED DESCRIPTION OF PREFERRED EMBODIMENTS

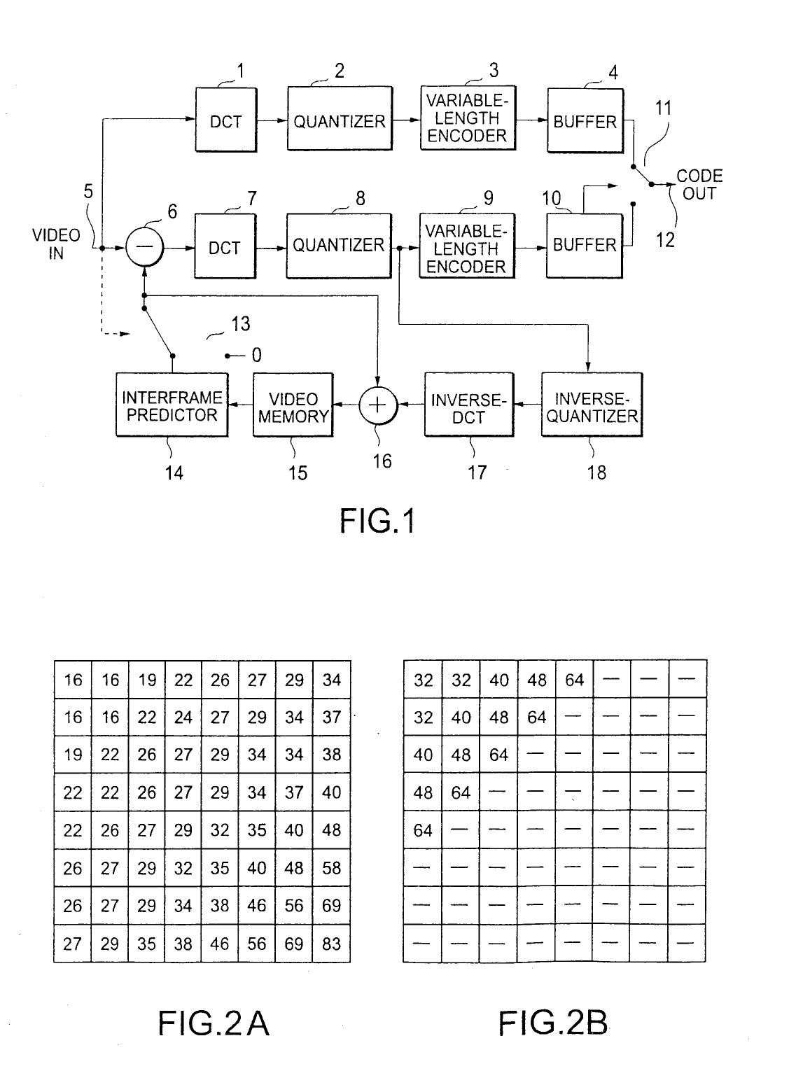

A preferred embodiment of the moving picture coding apparatus according to the present invention will be described with reference to FIGS. 1, 2A and 2B.

The coding apparatus shown in FIG. 1 conducts main coding processing and subsidiary coding processing. The apparatus is provided with a subsidiary coding processor including a discrete cosine transformer (DCT) 1, a quantizer 2, a variable-length encoder 3 and a buffer 4, all for the subsidiary coding processing. The apparatus is further provided with a main coding processor including a subtractor 6, a DCT 7, a quantizer 8, a variable-length encoder 9, a buffer 10, a switch 13, an interframe (predictive-coded frame) predictor 14, an video memory 15, an adder 16, an inverse-DCT 17 and an inverse-quantizer 18, all for the main coding processing. The apparatus also includes a switch 11 for switching output of the main and the subsidiary coding processing.

An input video signal is supplied, through an input terminal 5, to the DCT 1 for the subsidiary coding processing and also to the subtractor 6 for the main coding processing.

The main coding processing is described first. An interframe (predictive-coded frame) predictive signal is also supplied to the subtractor 6 from the interframe predictor 14 via switch 13. The subtractor 6 subtracts the interframe predictive signal from the input video signal to produce a predictive error signal.

The predictive error signal is supplied to the DCT 7 that conducts discrete cosine transform per (8×8) block of pixels carried by the predictive error signal. Produced coefficients are supplied to the quantizer 8 and quantized into fixed-length coefficients at a specific quantization step width. The fixed-length coefficients are then supplied to the variable-length encoder 9.

The two-dimensional (8×8) coefficients supplied to the variable-length encoder 9 are arranged according to a one-dimensional sequence known as the zigzag scanning and transformed into variable-length codes of zero coefficients and non-zero coefficients by Huffman coding. The predictive error signal thus transformed into the variable-length codes is supplied and stored in the buffer 10 as the main bit stream.

The fixed-length coefficients are also supplied from the quantizer 8 to the inverse-quantizer 18. The inverse-quantizer 18 and the inverse-DCT 17 conduct the processing which are the inverse of those of the quantizer 8 and DCT 7, respectively, to reproduce the predictive error signal.

The reproduced predictive error signal is added to the interframe predictive signal by the adder 16 to reproduce the video signal. The reproduced video signal is once stored in the video memory 15 and then supplied to the interframe predictor 14.

The interframe predictor 14 generates the interframe predictive signal that is then supplied to the switch 13. The generation of the interframe predictive signal may be done by motion compensation.

The switch 13 is controlled in synchronism with the incoming video signal. When the input video signal carries an independent (intra-picture coded) frame, the switch 13 selects the value zero and supplies the value to the subtractor 6 and the adder 16. The main coding processing in this case is the intraframe coding. The input video signal carries an independent frame for every 30th- to 120th-frame (conventionally 10th- to 20th-frame).

On the other hand, when the input video signal carries a predictive-coded frame, the switch 13 selects the interframe predictive signal from the interframe predictor 14. The selected interframe predictive signal is then supplied to the subtractor 6 and the adder 16. The main coding processing in this case is the interframe (predictive-coded frame) predictive coding. In detail, when the input video signal carries predictive-coded (P) frames obtained from preceding independent (I) frames or P frames in the sequence, the main coding processing executes unidirectional interframe predictive coding. Contrary to this, when the input video signal carries bidirectionally predictive-coded (B) frames obtained from the nearest preceding and/or following I or P frames in the sequence, the main coding processing executes bidirectional interframe predictive coding.

The subsidiary coding processing is described next. The input video signal supplied to the DCT 1 is applied discrete cosine transform per (8×8) block of pixels. Produced coefficients are supplied to the quantizer 2 and quantized into fixed-length coefficients at a specific quantization step width. The fixed-length coefficients are then supplied to the variable-length encoder 3.

The two-dimensional (8×8) coefficients supplied to the variable-length encoder 3 are arranged according to the zigzag scanning and transformed into variable-length codes of zero coefficients and non-zero coefficients by Huffman coding. The video signal thus transformed into the variable-length codes is supplied and stored in the buffer 4 as the subsidiary bit stream.

In the main and subsidiary coding processing, quantization steps for the quantizer 8 (main processing) and the quantizer 2 (subsidiary processing) are different from each other as follows:

FIGS. 2A and 2B show quantization steps (intraframe coding parameters) for the quantizers 8 and 2, respectively.

As shown, the quantization steps for the quantizer 2 are wider than those for the quantizer 8. In other words, the more distant from the DC component (“16” in FIG. 2A, “32” in FIG. 2B), the larger the coefficients of AC components for the quantizer 2 (FIG. 2B) compared to those for the quantizer 8 (FIG. 2A).

Furthermore, the larger the coefficients depicted as “-” in FIG. 2B, the wider the quantization steps, so that the quantized resultants are all zero in the subsidiary coding processing. This is also achieved by the variable-length encoder 3 to zigzag-scan the components from the DC component to several tens of the AC components to truncate the scanning.

A picture reproduced after the subsidiary coding processing thus exhibits low resolution. However, the amount of codes generated by the subsidiary coding processing is about 10 percent of that generated for an independent frame in the main coding processing.

The subsidiary bit stream thus obtained by the subsidiary coding processing is stored in the buffer 4.

The main and the subsidiary bit streams stored in the buffers 10 and 4, respectively, are switched by the switch 11 under the control of the buffer 10. The switch 11 is depicted as just a switch for easier understanding. However, the switch 11 has the function of multiplexing the main and the subsidiary bit streams, thus being realized by a multiplexing circuit. The output bit stream of the switch 11 may be stored in a storage medium. The output bit stream includes the main bit stream of independent frames, predictive-coded frames and the subsidiary bit streams periodically inserted in the main bit stream in the vicinity of (just before and after) a predetermined number of the predictive-coded frames. Multiplexed at the header of each bit stream is coding-type information that indicates whether the bit stream is the main or the subsidiary bit stream, and also whether the bit stream carries an independent frame (I or i) or predictive-coded frame (P or B). A predictive-coded frame with the subsidiary bit stream is generated for every 4th- to 12th-frame.

The coding in the present invention thus provides more predictive-coded frames with the subsidiary bit streams than the conventional coding that provides an independent frame for every 10th- to 20th-frame. Predictive-coded frames except those predictive-coded frames with the subsidiary bit streams are removed after the subsidiary coding processing or not coded by means of a switch (not shown) provided before the DCT 1.

Predictive-coded (P) frames obtained from preceding independent (I) frames or P frames in the sequence are objective of both the main subsidiary coding processing. On the other hand, bidirectionally predictive-coded (B) frames obtained from the nearest preceding and/or following I or P frames in the sequence are objective of the main coding processing but not of the subsidiary coding processing. Because the B frames are not used as reference frames for interframe prediction and thus no continuous decoding from the B frames being possible.

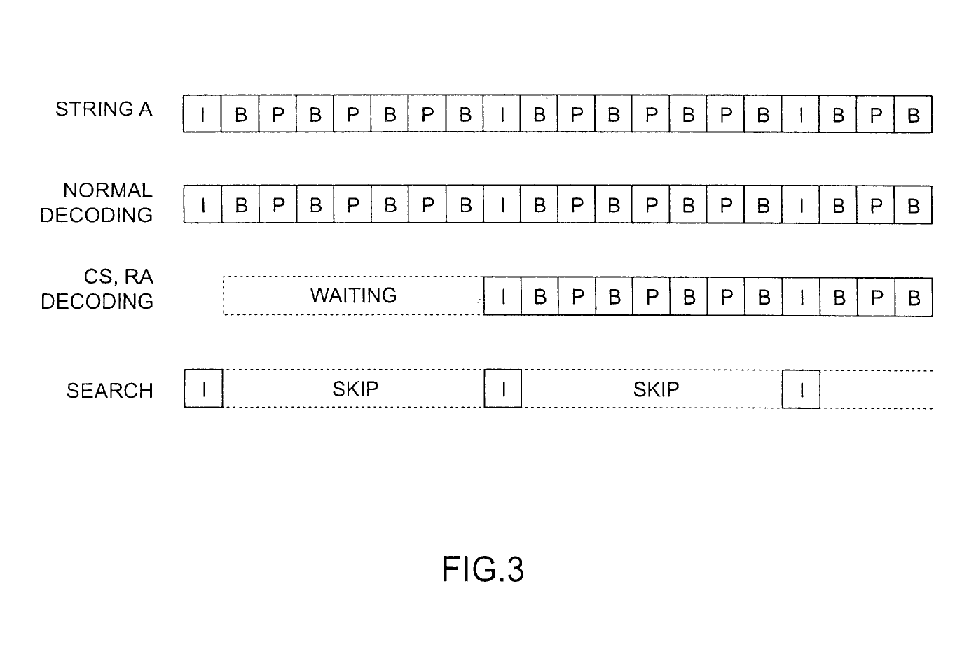

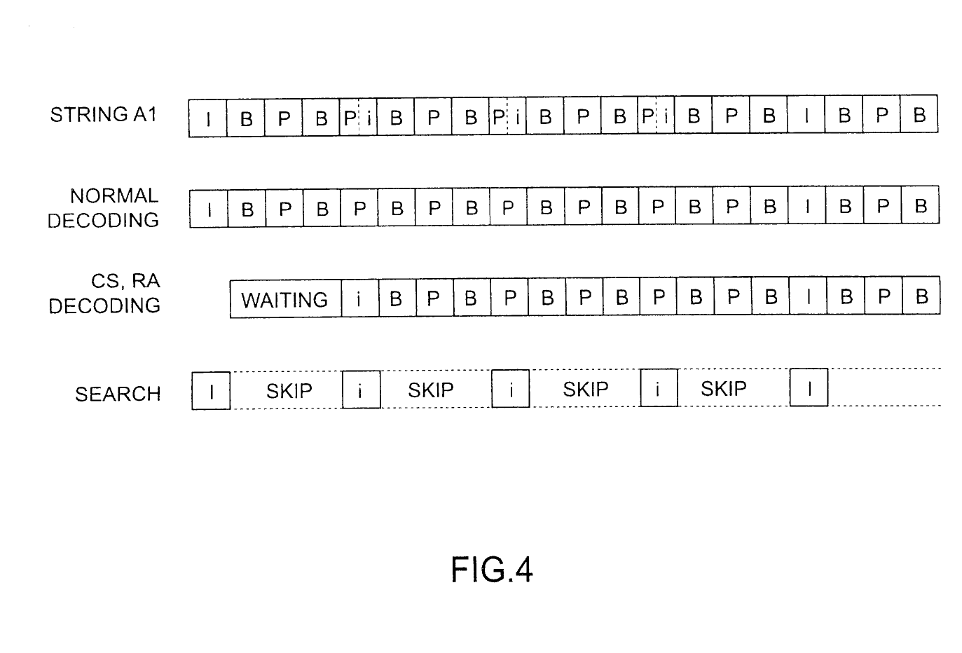

The bit streams and their timing are illustrated in FIGS. 3 and 4. The bit stream STRING A shown in FIG. 3 is generated by the conventional coding apparatus, and which consists of I, B and P frames. On the other hand, the bit stream STRING A1 shown in FIG. 4 is generated by the coding apparatus shown in FIG. 1 according to the present invention, and which consists of I, B and P frames, and also the subsidiary bit streams depicted as “i”. The length (amount of codes) of each bit stream shown in FIGS. 3 and 4 depends on frames that constitute the bit stream.

In the present invention, preferably, the subsidiary bit streams “i” follow the main bit streams for channel switching, etc., that is, the strings “i” follow the P frames as shown in STRING A1 of FIG. 4. Because the main bit streams decoded just after the subsidiary bit streams are decoded in channel switching.

On the other hand, the main bit streams may follow the subsidiary bit streams for error correction, etc., that is, the P frames follow the subsidiary bit streams “i” (This arrangement is not shown.).

Since the subsidiary bit streams are used only when errors are detected while the main bit stream are being decoded, the subsidiary bit streams should come first and kept for error concealment. Slices may be used for error concealment instead of frames for a smaller capacity of buffer to store the subsidiary bit streams in a decoding apparatus. In detail, once an error occurs in MPEG systems, that will affect not only the block where the error occurs but also other blocks or frames. When an error occurs, prediction halts in unit of slice within a frame to eliminate the effect of error.

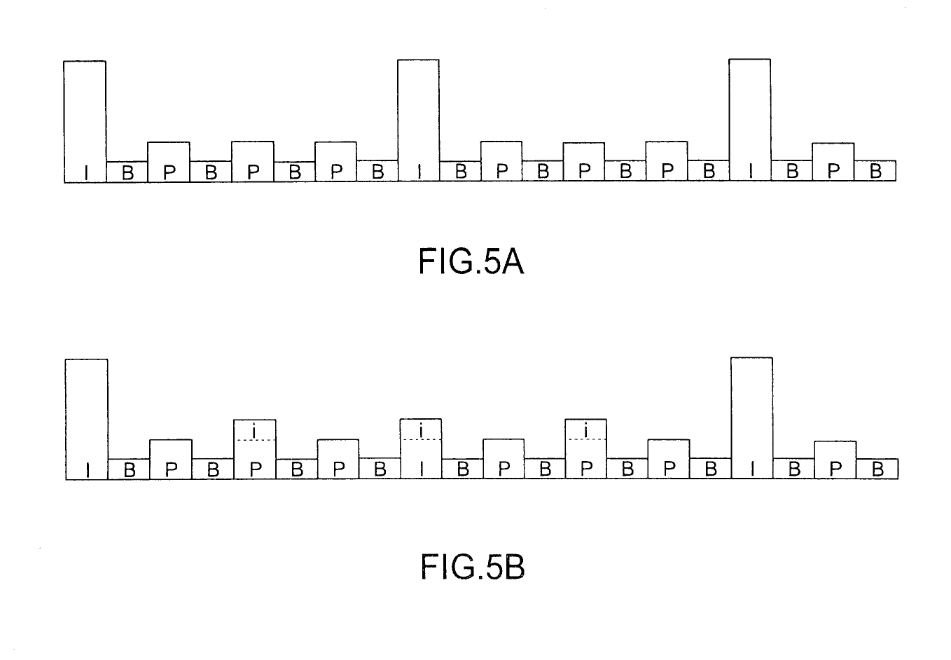

Output code amounts are illustrated in FIG. 5A for conventional coding and FIG. 5B for the present invention.

In the invention, the P frames with the subsidiary bit streams have a larger amount of codes than other P frames without subsidiary bit stream. However, the amounts of the codes of the P frames with the subsidiary bit streams are extremely smaller than those of the I frames.

Comparison is made in coding rate (efficiency) between the present invention and conventional coding.

Suppose that average code amounts of frames in the main bit stream are as follows:

I frame=600 kbits, P frame=200 kbits, B frame=100 kbits and “i” frame=100 kbits.

Conventionally, an interval M between P frames is two and an interval N between I frames is eight as shown in FIG. 5A, and the coding rate is 6. 0 Mb/s.

Compared to this, in the present invention, M=2, N=16 and an interval “n” between “i” frames is four as shown in FIG. 5B, and the coding rate is 5. 8 Mb/s. In detail, the coding rate for the main bit stream is 5. 24 Mb/s and that for the subsidiary bit stream is 0. 56 Mb/s.

Furthermore, in MPEG systems, conventionally M=3 and N=15, and the coding rate is 4. 8 Mb/s, on the other hand, the present invention provides M=3, N=60 and n=6, and the coding rate is 4.65 Mb/s. The cycle of the I frames is 0. 2 seconds for the present invention which is shorter than 0. 5 seconds for the conventional coding.

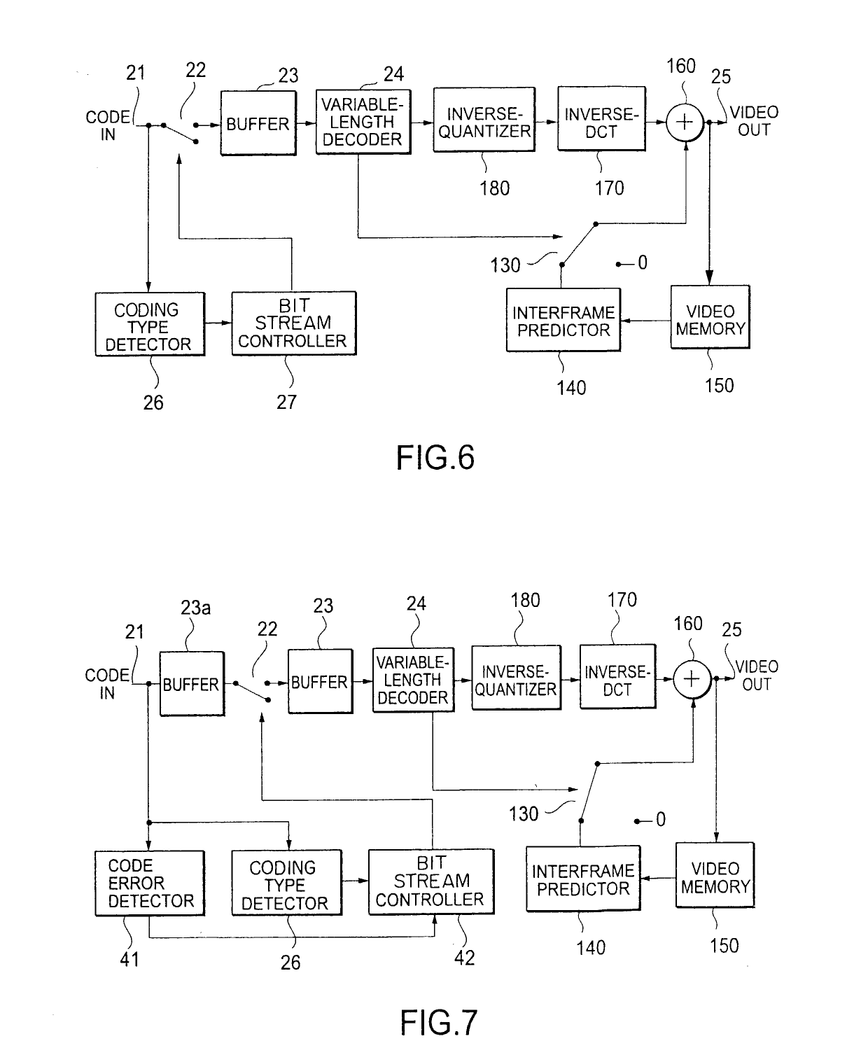

The first preferred embodiment of the a moving picture decoding apparatus according to the present invention will be described with reference to FIG. 6.

A bit stream output from a coding apparatus, such as the apparatus shown in FIG. 1 is supplied to a switch 22 and a coding-type detector 26 through an input terminal 21. The bit stream is switched per frame by the switch 22 that is controlled by a control signal from a bit stream controller 27. The bit stream corresponding to a predictive error signal is supplied to a variable-length decoder 24 via a buffer 23 and is transformed into fixed-length codes to obtain two-dimensional (8×8) coefficients. The coefficients are processed by an inverse-quantizer 180 and an inverse-DCT 170 to reproduce the predictive error signal. An interframe predictive signal is added to the predictive error signal by an adder 160 to reproduce a picture.

The reproduced picture is output through an output terminal 25 and also supplied to a video memory 150. The video memory 150 stores a picture of one frame and supplies it to an interframe predictor 140. The interframe predictor 140 produces an interframe predictive signal that is supplied to the adder 160 via a switch 130. The switch 130 selects the value zero when an independent frame is reproduced, thus no addition being proceeded.

The coding-type detector 26 detects the coding-type information multiplexed at the header of the input bit stream to decide whether the input bit stream is the main or the subsidiary bit stream, and carries an independent frame (I or i) or predictive-coded frame (P or B) and generates a coding-type signal. The bit stream controller 27 opens the switch 22 in response to the coding-type signal and removes the subsidiary bit stream when the standard bit stream is input at the usual timing and decoding is continuously performed. This is illustrated as NORMAL DECODING in FIG. 4 and which is the same as that in FIG. 3 for conventional decoding.

On the other hand, in the case of channel switching, random access or high speed search is conducted, the input bit stream is demultiplexed after switching, thus no continuous decoding is performed. Decoding processing is waiting until an independent frame (I or i) of the main or the subsidiary bit stream is input, and starts for the input independent frame.

After this independent frame is input, the standard bit stream is continuously input in the case of channel switching (CS) or random access (RA), thus decoding is continuously performed. This is illustrated as CS, RA DECODING in FIG. 4. Since the bit stream in the present invention contains more independent frames (I and i) than those in the conventional coding, the present invention achieves less waiting time for decoding in channel switching or random access than that illustrated as CS, RA DECODING in FIG. 3 in conventional decoding.

In the case of high-speed search, however, decoding processing is waiting until a next independent frame is input because the bit stream is demultiplexed again after the present independent frame is decoded. Either independent frames I of the main bit stream or subsidiary bit stream “i” may be reproduced for the high speed search. The former (I) reproduces pictures with resolution higher than pictures reproduced by the latter (i). On the contrary, the latter reproduces pictures with movement smoother than pictures reproduced by the former. Since the bit stream in the present invention contains more independent frames (I and i) than that in the conventional coding, the present invention achieves less skip time for decoding in high-speed search illustrated as SEARCH in FIG. 4 than that illustrated as SEARCH in FIG. 3 in the conventional decoding.

The second preferred embodiment of the moving picture decoding apparatus according to the present invention will be described with reference to FIG. 7. Elements in this embodiment that are the same as or analogous to elements in the first embodiment of the moving picture decoding apparatus are referenced by the same reference numerals and will not be explained in detail.

The decoding apparatus shown in FIG. 7 is provided with a buffer 23a and a code error detector 41 in addition to the elements the same as those shown in FIG. 6.

The coding-type detector 26 detects the coding-type information multiplexed at the head of the input bit stream to decide whether the input bit stream is the main or the subsidiary bit stream, and carries an independent frame (I or i) or predictive-coded frame (P or B) and generates a coding-type signal. A bit stream controller 42 opens the switch 22 in response to the coding-type signal and removes the subsidiary bit stream when the standard bit stream is input at the usual timing and decoding is continuously performed like the first embodiment shown in FIG. 6.

The code error detector 41 detects code errors occurred while the bit stream is being transmitted by a transmission line (not shown) connecting the decoding apparatus and a coding apparatus, such as, the apparatus shown in FIG. 1. When a code error is detected, the code error detector 41 outputs an error indicating signal that indicates at which portion of a picture the error occurs.

The bit stream controller 42 opens the switch 22 to remove the subsidiary bit stream when the error indicating signal supplied from the code error detector 41 indicates no error.

On the other hand, when an error occurs in the main bit stream, the bit stream is stored in the buffer 23a to wait the input of the subsidiary bit stream that corresponds to a picture to which the error occurs. The switch 22 then selects the input subsidiary bit stream and removes the main bit stream of a slice to which the error occurs.

When an error occurs in a frame, and no subsidiary bit stream is coded for the frame, the switch 22 selects the frame for decoding. However, the error effects later coming frames. When the subsidiary bit stream is input, which corresponds to a picture affected by the error, the switch 22 selects the input subsidiary bit stream and removes the main bit stream of a slice to which the error occurs. The effect of the error is thus eliminated at the moment of selecting the subsidiary bit stream.

Although not disclosed, motion compensation can be employed in this invention. In this case, an error occurred in a frame will affect other frames in accordance with the motion of picture. This means that the error occurred at a slice of the frame also affects other slices of the frames. The switch 22 in this case also selects the input subsidiary bit stream and removes the main bit stream of a slice to which the error occurs.

The bit streams STRING A1 shown in FIG. 4 can be recorded in this order on a storage medium according to the present invention.

More in detail, the storage medium according to the present invention which is readable by reproduction equipment including a decoding apparatus, such as the apparatus shown in FIG. 6 or 7, includes an area for storing moving picture data. The area has main bit stream regions stored on which are the main bit streams formed by intraframe coding and interframe predictive coding which are switched per frame or field of moving pictures. The area also has subsidiary bit stream regions stored on which are the subsidiary bit streams formed by intraframe coding specific frames among frames that are also coded by the interframe predictive coding. The main and subsidiary bit streams are multiplexed so that subsidiary bit streams are inserted in the vicinity of the main bit streams for specific frames, as described with reference to FIG. 1.

The present invention is disclosed for processing a video signal in unit of frame, however, this invention is also applicable to processing a video signal in unit of field.

What is claimed is:

1. An apparatus for efficiently coding a moving picture signal, comprising:
a main coding processor to selectively encode an input moving picture signal by intra-picture coding or inter-picture coding in unit of frame or field to output a main bit stream;
a subsidiary coding processor to encode specific frames or fields carried by the input moving picture signal by intra-picture coding to output a subsidiary bit stream, the specific frames or fields being also coded by the inter-picture coding by the main coding processor; and
a multiplexer to multiplex the main and subsidiary bit streams so that the subsidiary bit streams are periodically inserted in the main bit stream in the vicinity of a predetermined number of the frames or fields coded by the inter-picture coding, thus generating an output bit stream.

2. The apparatus according to claim 1, wherein the main and the subsidiary coding processors execute the intra-picture coding with different coding parameters.

3. The apparatus according to claim 1, wherein the main coding processor selectively executes uni-directional predictive coding and bidirectional predictive coding in unit of frame or field.

4. The apparatus according to claim 3, wherein the subsidiary coding processor encodes the specific frames or fields that are also coded by the unidirectional predictive coding by the main coding processor.

5. An apparatus for efficiently decoding a moving picture signal, comprising:
a detector to detect a coding-type of an input bit stream formed by multiplexing a main bit stream of frames or fields and subsidiary bit streams, the subsidiary bit streams being periodically inserted in the main bit stream in the vicinity of a predetermined number of the frames or fields, the main bit stream having been coded at quantization steps finer than other quantization steps at which the subsidiary bit streams having been coded, and a coding-type information indicating whether the main bit stream is or the subsidiary bit streams string are input, the detector detecting the coding-type information and generating a coding-type signal;
a controller to selectively output the main and the subsidiary bit streams in response to at least the coding-type signal in such a way that the controller outputs both the main and the subsidiary bit streams when no continuous decoding is being performed, while the controller outputs only the main bit stream when continuous decoding is being performed; and
a decoder to decode the output bit stream to reproduce pictures carried by the input bit stream.

6. An apparatus for efficiently decoding a moving picture signal, comprising:
a first detector to detect a coding-type of an input bit stream formed by multiplexing a main bit stream of frames or fields and subsidiary bit streams, the subsidiary bit streams being periodically inserted in the main bit stream in the vicinity of a predetermined number of the frames or fields, the main bit stream having been coded at quantization steps finer than other quantization steps at which the subsidiary bit streams having been coded, and a coding-type information indicating whether the main bit stream is or the subsidiary bet streams are input, the detector detecting the coding-type information and generating a coding-type signal;
a second detector to detect an error of the input bit stream and generating an error indicating signal that indicates at which of the frames or fields the error occurs;
a controller, in response to the coding-type and error indicating signals, to replace the main bit stream of a frame or field with a subsidiary bit stream inserted in the vicinity thereof at which the error occurs with the subsidiary bit stream; and
a decoder to decode an output bit stream of the controller by intra-picture decoding or inter-picture predictive decoding to reproduce pictures carried by the input bit stream.

7. A method of efficiently coding a moving picture signal, comprising the steps of:
selectively encoding an input moving picture signal by intra-picture coding or inter-picture coding in unit of frame or field to output a main bit stream;
encoding specific frames or fields carried by the input moving picture signal by intra-picture coding to output a subsidiary bit stream, the specific frames or fields being also coded by the inter-picture coding by the main coding processor; and
multiplexing the main and subsidiary bit streams so that the subsidiary bit streams are periodically inserted in the main bit stream in the vicinity of a predetermined number of the frames or fields coded by the inter-picture coding, thus generating an output bit stream.

8. The method according to claim 7, wherein both the selective encoding step and the specific frame or field encoding step include the step of executing the intra-picture coding with different coding parameters.

9. The method according to claim 7, wherein the selective encoding step includes the step of selectively executing unidirectional predictive coding and bidirectional predictive coding in unit of frame or field.

10. The method according to claim 9, wherein the specific frame or field encoding step includes the step of encoding the specific frames or fields that are also coded by the unidirectional predictive coding.

11. A method of efficiently decoding a moving picture signal, comprising:
detecting a coding-type of an input bit stream formed by multiplexing a main bit stream of frames or fields and subsidiary bit streams, the subsidiary bit streams being periodically inserted in the main bit stream in the vicinity of a predetermined number of the frames or fields, the main bit stream having been coded at quantization steps finer than other quantization steps at which the subsidiary bit streams having been coded, and a coding-type information indicating whether the main bit stream is or the subsidiary bet streams string are input, the detector detecting the coding-type information and generating a coding-type signal;
selectively outputting the main and the subsidiary bit streams in response to at least the coding-type signal in such a way that the controller outputs both the main and the subsidiary bit streams when no continuous decoding is being performed, while the controller outputs only the main bit stream when continuous decoding is being performed; and
decoding the output bit stream to reproduce pictures carried by the input bit stream.

12. A method of efficiently decoding a moving picture signal, comprising the steps of:
detecting a coding-type of an input bit stream formed by multiplexing a main bit stream of frames or fields and subsidiary bit streams, the subsidiary bit streams being periodically inserted in the main bit stream in the vicinity of a predetermined number of the frames or fields, the main bit stream having been coded at quantization steps finer than other quantization steps at which the subsidiary bit streams having been coded, and a coding-type information indicating whether the main bit stream is or the subsidiary bit streams are input, the coding-type information being detected, and generating a coding-type signal;
detecting an error of the input bit stream and generating an error indicating signal that indicates at which of the frames or fields the error occurs;
replacing the main bit stream of a frame or field with a subsidiary bit stream inserted in the vicinity thereof at which the error occurs with the subsidiary bit stream in response to the coding-type and error indicating signals; and
decoding the bit stream for which the main bit stream is replaced with the subsidiary bit stream by intra-picture decoding or inter-picture predictive decoding to reproduce pictures carried by the input bit stream.

13. A storage medium comprising an area for storing moving picture data, the area including main bit stream regions stored on which are main bit streams formed by intra-picture coding and inter-picture predictive coding which are switched per frame or field of moving pictures, and subsidiary bit stream regions stored on which are subsidiary bit streams formed by intra-picture coding specific frames among frames that are also coded by the inter-picture predictive coding, the main and subsidiary bit streams being multiplexed so that the subsidiary bit streams being inserted in the vicinity of the main bit streams for specific frames or fields.
